(19) United States
(12) Patent Application Publication
(10) Pub. No.: US 2005/0080641 A1
(43) Pub. Date: Apr. 14, 2005

(54) System and method for selecting a battery

(75) Inventors: Bruce A. Ronning, Menomonee Falls, WI (US); David J. Novak, Menomonee Falls, WI (US); William J. Wruck, Whitefish Bay, WI (US); Majid Taghikhani, Franklin, WI (US); Edward N. Mrotek, Grafton, WI (US); Robert G. Gruenstern, Germantown, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/684,788

(22) Filed: Oct. 14, 2003

(51) Int. Cl. G06F 17/60

(52) U.S. Cl. 705/1

(57) ABSTRACT

A method of selecting a battery for a vehicle includes identifying a plurality of batteries and obtaining ratings for a plurality of characteristics for each of the plurality of batteries. The method also includes obtaining information relating to the usage of the vehicle and identifying a battery for use with the vehicle based on the ratings and the information relating to the usage of the vehicle. The method may also include weighting a plurality of the ratings and utilizing the weighted ratings to identify an optimal battery.

### BACKGROUND

The present invention relates to a battery selection system and method. The present invention more specifically relates to a system and method configured to assist with the selection of a battery that is appropriate for a vehicle and its intended use.

Vehicles such as automobiles (e.g., cars, trucks, etc.) utilize one or more batteries to provide power for various features and applications provided in the vehicle. For example, vehicles may use a 12 Volt (V) lead-acid battery for starting, lighting, and ignition applications. Other applications that require power may include drive-by-wire applications, vehicle entertainment systems, and others.

It may be desirable to replace such batteries for a variety of reasons. For example, after a period of use (e.g., several years), such batteries may require replacement (e.g., the battery may exhibit reduced capacity, starting ability, or other performance characteristics). In another example, a vehicle owner may prefer to utilize a battery that exhibits particular performance characteristics not provided by a battery currently being utilized.

To select or determine an appropriate battery for a particular vehicle, various considerations may be utilized, including past experience, common knowledge, need or urgency, recommendations by others (e.g., mechanics or service technicians), pricing, and availability. Various sources may be consulted, including the vehicle user's manual, commercial literature, catalogs, and/or databases.

Vehicle user's manuals and other sources typically base battery selection recommendations on the “group size” of the battery (i.e., the physical dimensions of the battery), the required “cold cranking amps” (CCA) for the vehicle (i.e., the number of amperes the battery can support for 30 seconds at a temperature of 0 degrees Fahrenheit until the voltage of the battery drops to “unusable” levels; e.g., a 12 V battery with a rating of 600 CCA indicates that the battery will provide 600 amps for 30 seconds at 0 degrees Fahrenheit before the battery voltage falls below 7.2 V), and the required “reserve capacity” (RC) for the vehicle (i.e., how well the battery should power the electrical system of the vehicle if the alternator fails; e.g., the amount of time the battery should be able to supply power without falling below a minimum voltage needed to run the vehicle).

Information available from such known sources may be inadequate to allow for selection or identification of a battery that is optimal for use with a particular vehicle (e.g., based on the actual or intended use of the vehicle). For example, such information may not provide a systematic evaluation of various performance, environmental, use, and economic parameters required for a particular application in selecting from a number of batteries having particular price and performance characteristics.

Accordingly, it would be advantageous to provide a system and method that considers various factors (e.g., performance, environment, use, economics, etc.) to identify or select a battery. It would also be advantageous to provide a system and method that systematically evaluates application-specific information or inputs to identify an appropriate battery for a particular application. It would also be advantageous to provide a system that may be relatively easily configured to assist in the identification of a battery for a particular application. It would also be advantageous to provide a system and method that provides battery selection information in a relatively clear and concise manner. It would also be advantageous to provide a system that assists consumers and/or other individuals (e.g., mechanics, technicians, salespeople, etc.) in selecting an appropriate battery for a particular vehicle application.

### SUMMARY

The present invention relates to a method of selecting a battery for a vehicle. The method includes identifying a plurality of batteries and obtaining ratings for a plurality of characteristics for each of the plurality of batteries. The method also includes obtaining information relating to the usage of the vehicle and identifying a battery for use with the vehicle based on the ratings and the information relating to the usage of the vehicle.

The present invention also relates to a method of identifying an optimal battery for an application. The method includes identifying a plurality of batteries for use in the application and obtaining ratings for a plurality of characteristics for each of the plurality of batteries. The method also includes obtaining information relating to usage characteristics of the application, weighting a plurality of the ratings based on the information relating to usage characteristics of the application, and utilizing the weighted ratings to identify an optimal battery for the application.

The present invention also relates to a system for selecting a battery. The system includes a user interface for facilitating input of information relating to a type of vehicle and the use of the vehicle and an electronic system for identifying a plurality of batteries for use with the vehicle, obtaining ratings of a plurality of characteristics for the plurality of batteries, and identifying one of the plurality of batteries as most appropriate based on the ratings and the information relating to the use of the vehicle.

It would be advantageous to provide a method or system or the like of a type disclosed in the present application that provides any one or more of these or other advantageous features.

### BRIEF DESCRIPTION OF THE DRAWINGS

FIG. 1 is a flow diagram showing steps to be performed by a battery selection system according to an exemplary embodiment.

FIG. 2 is a perspective view of a retail environment including a variety of embodiments or implementations of battery selection systems according to various exemplary embodiments.

FIG. 3 is a schematic block diagram showing another embodiment or implementation of a battery selection system according to another exemplary embodiment.

FIGS. 4A through 4K are schematic views of user interfaces for a battery selection system according to an exemplary embodiment.

### DETAILED DESCRIPTION OF PREFERRED AND EXEMPLARY EMBODIMENTS

According to an exemplary embodiment, a battery selection system and method are provided to help or assist an individual (e.g., a consumer, salesperson, store employee, or other individual) in identifying or selecting (e.g., choosing) a battery (e.g., a lead-acid automotive storage or starting, lighting, and ignition battery) that is optimal and/or most appropriate (e.g., preferred, most favorable, ideal, etc.) for a particular application or vehicle. Information relating to various factors or characteristics (e.g., features, attributes, properties, traits, elements, etc.) is collected from the individual (such as the type of vehicle, actual or intended vehicle usage, performance, environment, economics, etc.). Such information is evaluated in an effort to identify or determine which commercially available battery (or batteries) may be most appropriate for the application or vehicle and its actual or intended use.

The information collected may generally be considered to be divided into a number of information sets or categories. For example, one set of information relates to the type of vehicle and may include the year the vehicle was manufactured and the make and model of the vehicle. Another set of information relates to the actual and/or intended usage of the vehicle (i.e., the driving profile) and may include how and where the vehicle is typically used, the mileage of the vehicle, whether the vehicle is typically driven in the city or on the highway, and how long the consumer intends to use the vehicle. Another set of information relates to the desired performance characteristics of the battery and may include the cold cranking capability, reserve capacity, heat resistance, vibration resistance, and whether the battery is serviceable or “sealed” (e.g., whether the battery is “flooded” or has an absorptive glass mat (AGM)). Another set of information relates to the desired economic or cost characteristics of the battery and may include a retail price and a warranty period.

Any of a variety of other information may also be collected by the battery selection system. According to other exemplary embodiments, each of the information sets may include additional and/or different information. According to still other exemplary embodiments, additional and/or different sets of information may be collected (e.g., pertaining to information representative of preferences of the user).

In general, the collected information is compiled and evaluated by the battery selection system with reference to various characteristics (e.g., performance, price, etc.) of commercially available batteries. The battery selection system indicates which battery (or batteries) is most appropriate for the vehicle and its actual or intended use (e.g., by ranking several available batteries in order of appropriateness). For example, a battery having relatively high heat resistance and low reserve capacity may be ranked as less appropriate for a passenger vehicle driven only occasional long distances on uncongested highways, and ranked as more appropriate for a sport utility vehicle driven many short distances in congested traffic.

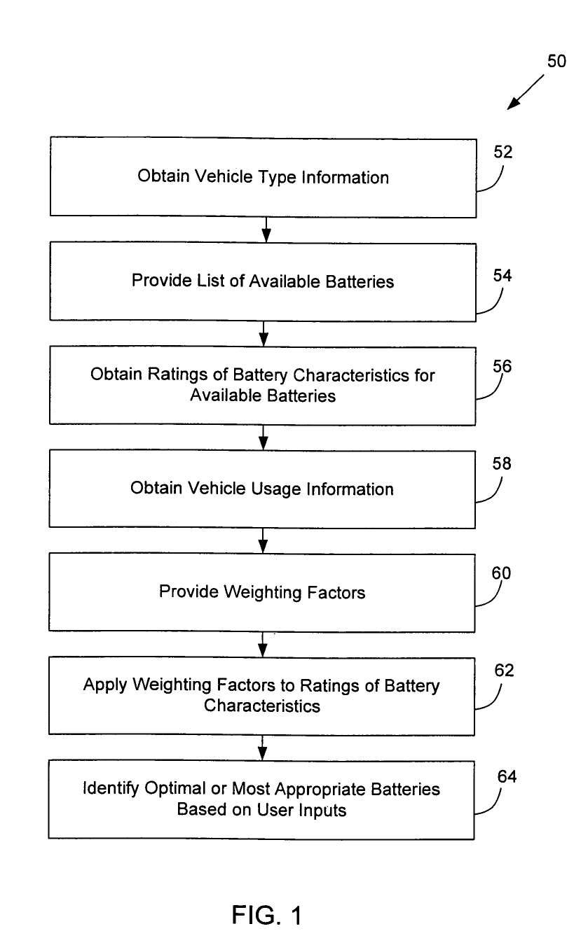

As shown in FIG. 1, according to an exemplary embodiment, the battery selection system utilizes a method in the form of a routine or algorithm 50 to select a battery that is optimal or most appropriate for the type of vehicle and its actual or intended use.

Information relating to the type of vehicle is collected by the battery selection system (step 52). Such information may include the year of manufacture, make, and model of the vehicle in which the battery will be used. Such information may also include information regarding the type of battery provided with the vehicle (e.g., the OEM battery) and/or currently used by the vehicle according to an alternative embodiment. Various methods of collecting information relating to the type of vehicle may be used, including direct input of the information in a user interface (e.g., using a keyboard, mouse, etc.) and scanning a bar code or other object using a scanning device (e.g., scanning a bar code in a list of vehicles, in which the bar code is indicative of vehicle information).

Based on the information relating to the type of vehicle, the battery selection system obtains or provides an initial list of batteries that are available for use with such a vehicle (step 54). The list is based on original equipment manufacturer recommendations, physical dimensions of the battery (i.e., group size) and of the vehicle (e.g., battery compartment dimensions), and other factors according to a preferred embodiment. For example, the battery selection system may provide a list that includes four batteries that are appropriate for the make, model and year of a vehicle (e.g., Battery A, Battery B, Battery C and Battery D). In other examples, the number of batteries identified may differ.

According to an exemplary embodiment, the initial list of batteries provided by the battery selection system includes only those batteries that are available in a particular location (e.g., if “Battery X” may be used for a particular vehicle but is not available for sale from a particular retailer, the battery selection system may omit “Battery X” from the list of available batteries). According to another exemplary embodiment, the initial list of batteries may include batteries that are not offered for sale in a particular location (e.g., the list may include all batteries that may be used with a particular vehicle).

According to an alternative embodiment, an initial list of batteries is not provided, and the information relating to the type of vehicle may be utilized as an input for the battery selection system in ranking batteries as will be described in more detail below.

The battery selection system may obtain or utilize ratings (e.g., grades, scores, classifications, assignments, designations, rankings, values, etc.) of various characteristics (e.g., features, parameters, etc.) of the batteries included in the initial list of batteries obtained (step 56). Table 1 illustrates ratings for eight battery characteristics (e.g., cold cranking capability, heat resistance, reserve capacity, vibration resistance, sealed/flooded, cycle capability, acid over the plates, warranty, etc.) for the four batteries included in the initial list of available batteries according to an exemplary embodiment.

TABLE 1

| | Ratings of Battery Characteristics | | | |
|---|---|---|---|---|
| Characteristic | Battery A | Battery B | Battery C | Battery D |
| 1. Cold Cranking | 1 | 2 | 3 | 2 |
| Capability (CCA) | | | | |
| 2. Heat Resistance | 1 | 3 | 3 | 2 |
| 3. Reserve Capacity | 1 | 2 | 3 | 2 |
| 4. Vibration Resistance | 1 | 2 | 2 | 3 |
| 5. Sealed | 1 | 1 | 1 | 3 |
| 6. Warranty | 1 | 2 | 3 | 3 |
| 7. Cycle Capability | 1 | 1 | 1 | 3 |
| 8. Acid over plates (ml/ | 2 | 2 | 1 | 3 |
| AH-recomb) | | | | |
| NON-WEIGHTED | 9 | 15 | 17 | 21 |
| TOTAL | | | | |

According to alternative embodiments, greater or fewer characteristics may be rated for each of the batteries and/or one or more different and/or additional characteristics may also be rated. It should also be noted that while the data is shown as being presented in a table, the battery selection system may operate without inserting the ratings and other information in a table (e.g., by the battery selection system may insert the values into a formula used by an algorithm, etc.). According to other exemplary embodiments, the data may be utilized in conjunction with other types of data organization systems (e.g., charts, graphs, schemes, plans, diagrams, etc.).

Ratings for each battery characteristic (e.g., such as those included in Table 1) may be obtained from a variety of sources (step 56). For example, the ratings may be obtained from a lookup table or database that is accessible by the battery selection system (e.g., stored locally in a computer memory or hard drive). In another example, the ratings may be obtained over a network connection (e.g., local area network, wide area network, Internet, etc.) by the battery selection system. Various other sources for the ratings may also be utilized.

According to an exemplary embodiment, the higher the number shown for a given characteristic, the better the battery performs in that area (i.e., the higher the rating). For example, Battery A may have a relatively low cold cranking capability (e.g., about 570 CCA to about 640 CCA and assigned a value of “1” in TABLE 1), and Battery C may have a relatively high cold cranking capability (e.g., about 655 CCA to about 800 CCA and assigned a value “3” in TABLE 1). According to other exemplary embodiments, other systems for rating the various characteristics may be used (e.g., the lower the number, the better the performance, etc.).

As shown in Table 1, Battery D is the most highly rated battery overall included in the initial list, based on sum of the ratings (i.e., the sum or total of the ratings for each of the eight characteristics is greater for Battery D than for any other battery). The sum or total is a non-weighted sum or total. That is, each battery characteristic is treated as being equally relevant or important in arriving at the total.

According to an exemplary embodiment, the battery selection system may provide a list of batteries ranked by overall performance (e.g., the non-weighted sums of the ratings for each of the batteries may be obtained and used to rank the overall performance of the batteries), in which case Battery D would be the most highly ranked. According to an alternative embodiment, the battery selection system may indicate only the most highly rated battery included in the initial list (e.g., only Battery D would be listed). Individuals interested in obtaining the battery which exhibits superior overall performance based on the eight rated battery characteristics may then choose to purchase Battery D.

Other individuals, however, may desire to obtain a battery that is most appropriate for their particular usage circumstances. In such a case, according to a preferred embodiment, the initial list of batteries provided in step 54 are evaluated based on information relating to the likely use of the vehicle and other information, after which the battery selection system recommends or selects a battery (or ranks the batteries) that is most appropriate for the type of vehicle and its actual or intended use. According to this embodiment, the various battery characteristics are weighted according to various inputs provided by an individual using the battery selection system.

According to a preferred embodiment, the battery selection system obtains information relating to the actual or intended use of the vehicle, desired performance characteristics, and/or economic, cost, and warranty preferences in the form of responses to questions presented by the battery selection system (step 58). A list of several possible questions is provided in TABLE 2. The questions shown in Table 2 are nonexclusive examples of questions designed to elicit information from a user of the battery selection system related to the use of the vehicle and various other considerations that may be relevant in identifying or selecting an appropriate battery for a particular vehicle. The battery selection system may utilize any one or more of these questions or may use additional or different questions according to various exemplary embodiments. The number and type of questions shown and described herein are intended to be representative of the questions which may be used by the battery selection system, and are not intended to limit the scope of the invention as defined in the appended claims.

TABLE 2
What is your zip code?
What is the zip code of the point of purchase of your vehicle (which may
be predetermined)?
How many hours is your vehicle driven per day?
How many miles is your car driven per year?
How many times is your vehicle typically driven per day?
How many miles is your vehicle typically driven to work?
What is the odometer reading of your vehicle?
How long do you plan to keep your vehicle?
Do you desire a battery warranty greater than 2 years?
Is your vehicle driven primarily in urban or rural settings?
Do you store your vehicle?
How much time is your vehicle not in use?
Is your vehicle typically driven all year?
Is your vehicle typically driven off-road?
Is your vehicle typically driven for personal or commercial use?
Does your vehicle have optional accessories (e.g. headlamp, winch, etc.)?
Is your vehicle used for towing?
Do you weld with your battery?
What modifications have you made to your vehicle (e.g., speakers,
headlights)?
Does your battery require “dual battery” setup?
Do you maintain (e.g., add water to) your battery?
What type of battery do you have today?
Have you ever replaced the battery for your vehicle? When?
How long have you had your battery?
Where did you purchase your last battery?
Will you install your battery or have it installed?
How much money do you want to spend on the battery?

Responses to each of the questions presented by the battery selection system are utilized to determine or provide weighting factors for use in identifying or determining an appropriate battery. For example, the battery selection system may present a consumer with the question “How many miles is your car driven per year?” The consumer inputs an answer to the question (e.g., by entering a number or range of miles as free form text, by selecting a number or range of miles from a pull-down menu or list, etc.). The battery selection system then determines or provides a weighting factor for one or more battery characteristic ratings based on the answer input by the consumer.

The weighting factor is generated or provided based on the information provided by the user of the battery selection system. Information input by the user may be used directly to determine a weighting factor. For example, answers to “yes”/“no” type questions may be utilized to provide weighting factors (e.g., a “yes” corresponds to a weighting factor of “4” for a particular characteristic rating and a “no” corresponds to a weighting factor of “0” for a particular characteristic rating). In another example, an input of a particular number of miles per year the vehicle is to be driven may be used to determine a weighting factor.

Such weighting factors may also be generated or provided based on inferences or assumptions related to the information provided by the user. For example, information provided by the user relating to the mileage of the vehicle and the year of the vehicle may indicate that the vehicle is driven a relatively long distance per year (e.g., an odometer reading of 60,000 miles for a 3 year old car would be equivalent to 20,000 miles per year, which may correspond to a weighting factor of “4”).

In another example, information provided by the user relating to a zip code may be used to infer the temperature and/or urban/rural environment in which the battery will be used (e.g., with reference to a lookup table or other source such as a weather station or traffic report for a particular zip code, etc.), which may be used to assign particular weighting factors. For example, if the information collected relating to address or zip code of the user corresponds to a city having a high population density, then the battery selection system may make an assumption that a “city” or stop-and-start type drive profile is likely, and a weighting factor may be assigned accordingly.

In a further example, information provided by the user relating to the type of vehicle may indicate that the vehicle is likely to be driven off-road or that the vehicle has certain accessories, which may be used to assign particular weighting factors.

Information from the user may also be used by the battery selection system to provide weighting factors for more than one battery characteristic. For example, if the information input by the user indicates that the vehicle is likely to be used as a high mileage or commuter vehicle, then the battery selection system may provide a relatively high weighting factor (e.g., a “4”) for “heat resistance,” a moderate weighting factor (e.g., a “2”) for vibration resistance, and a relatively low weighting factor (e.g., a “1” or “0”) for reserve capacity and cycle capability. Other information input by a user (e.g., zip code, etc.) may implicate different and/or additional battery characteristics.

Table 3 illustrates one possible example of a set of weighting factors provided by the battery selection system in response to various information (e.g., answers to questions) input by a consumer. According to this embodiment, the answers provided by the consumer are representative of a vehicle owner who drives a vehicle without optional vehicle accessories frequently for long distances on congested highways in warm climates, does not plan to keep the vehicle for an extended period, does not desire a lengthy warranty, and maintains the battery. The answers to each of the questions presented are shown in Table 2 in non-limiting fashion.

TABLE 3

| | | Weighting Factors For Battery Characteristics | | | | | | | |
|---|---|---|---|---|---|---|---|---|---|
| | | | Heat | Reserve | Vibration | | | Cycle | Acid over |
| Question | Answer | CCA | Resistance | Capacity | Resistance | Sealed | Warranty | Capability | plates |
| 1. How many | 30,000 | | 4 | 0 | 2 | | | 0 | |
| miles is your car | | | | | | | | | |
| driven per year? | | | | | | | | | |
| 2. What is your | 85001 | 0 | 4 | | | | | | 3 |
| zip code? | | | | | | | | | |
| 3. Is your vehicle | Urban | | | 0 | | | | | |
| driven primarily | | | | | | | | | |
| in urban or rural | | | | | | | | | |
| settings? | | | | | | | | | |
| 4. How many | 6 | | 3 | | | | | | |
| hours is your | | | | | | | | | |
| vehicle driven per | | | | | | | | | |
| day? | | | | | | | | | |
| 5. Does your | Yes | | | 0 | | | | | |
| vehicle have | | | | | | | | | |
| optional | | | | | | | | | |
| accessories (e.g. | | | | | | | | | |
| headlamp, winch, | | | | | | | | | |
| etc.)? | | | | | | | | | |
| 6. How long do | 1 Year | | | | | | 0 | | |
| you plan to keep | | | | | | | | | |
| your vehicle? | | | | | | | | | |
| 7. Do you desire a | No | | | | | | 0 | | |
| battery warranty | | | | | | | | | |
| greater than 2 | | | | | | | | | |
| years? | | | | | | | | | |
| 8. Do you | Yes | | | 0 | | 0 | | | 0 |
| maintain your | | | | | | | | | |
| battery? | | | | | | | | | |

| | | | | | | | | |
|---|---|---|---|---|---|---|---|---|
| TOTAL WEIGHTING | 0 | 11 | 0 | 2 | 0 | 0 | 0 | 3 |
| FACTOR | | | | | | | | |

As shown in FIG. 1, the battery selection system provides weighting factors (step 60) for the various battery characteristics based on the answers provided (see, e.g., Table 1). For example, the answer to the first question shown in Table 3 indicates that a large amount of miles are to be accumulated per year. This information implicates several battery characteristics, including the heat resistance, reserve capacity, vibration resistance, and cycle capability of the battery. The battery selection system in this case determines that the heat resistance should receive a weighting factor of “4,” the reserve capacity should receive a weighting factor of “0”, the vibration resistance should receive a weighting factor of “2,” and the cycle capability should receive a weighting factor of “0.” Other battery characteristics are not implicated. For example, as shown in Table 3, the cold cranking capability, warranty period, and whether the battery should be sealed or have acid over the plates are not implicated, and therefore do not receive a weighting factor based on the answer to the first question.

The manner in which weighting factors for each of the battery characteristics is determined may vary according to alternative embodiments. For example, in the example shown in Table 3, the weighting factors assigned to the four battery characteristics based on the answer to the first question are not equal for each battery characteristic for which weighting factors are assigned. In this example, it may have been determined that a large number of miles per year has a greater relevance for heat resistance than for vibration resistance, and that it has an inverse relationship with reserve capacity. According to another exemplary embodiment, those characteristics that are not relevant to the consumer may receive a weighting factor of “1” instead of “0.”

Any of a variety of considerations may be used to provide or determine weighting factors for battery characteristics based on answers to questions according to alternative embodiments. Answers to certain questions may implicate any number of battery characteristics being evaluated by the battery selection system. The particular weighting factors assigned may vary according to various alternative embodiments, and are provided in a manner intended to assist the battery selection system in determining the batteries that are most suitable for a particular vehicle.

Because answers to more than one question may implicate particular battery characteristics (e.g., the first and second questions implicate the heat resistance characteristic of the battery as shown in Table 3), the weighting factors for each battery characteristic are summed or added to provide a total weighting factor for each battery characteristic. The total weighting factors are shown in the bottom row in Table 3 by way of example. As shown in Table 3, the heat resistance of the battery receives the largest weighting factor, meaning that such a characteristic may be most relevant or important for the consumer or other individual providing the answers shown in Table 3. Various other factors (e.g., reserve capacity) are determined to be irrelevant to the consumer, and thus receive a weighting factor of zero.

As shown in FIG. 1, the total weighting factors for each battery characteristic (step 62) are applied to the corresponding ratings of battery characteristics (shown, e.g., in Table 2). According to an exemplary embodiment, the ratings are multiplied by the corresponding total weighting factor to produce a weighted rating of each of the battery characteristics to be evaluated (e.g., the heat resistance ratings for each of the batteries are multiplied by a weighting factor of “11”, which is the total heat resistance weighting factor shown in Table 3). According to alternative embodiments, the total weighting factor may be applied to the ratings in other manners. For example, the ratings may have the total weighting factors added to them or may be divided by the total weighting factors. Other operations may also be performed (e.g., various formulae may be used to apply the weighting factors to the ratings) according to alternative embodiments.

Table 4 shows the weighted ratings for each of the battery characteristics according to an embodiment in which the ratings provided in Table 2 are multiplied by the corresponding total weighting factors provided in Table 3. As shown in Table 4, after the ratings for the various battery characteristics are weighted, Battery B has the highest overall rating, as indicated by the bottom row of Table 4. Thus, while Battery B was initially ranked third without taking into account various information provided by the consumer (e.g., with all battery characteristics being weighted equally), based on the needs of the consumer, Battery B would be identified or selected as the most appropriate battery for the user. Accordingly, as shown in FIG. 1, the battery selection system identifies or recommends (in step 64) the battery that is optimal or most appropriate for the consumer (e.g., by providing a list of the batteries in ranked order, by presenting only the most suitable battery, etc.).

TABLE 4

| | Weighted Ratings of Battery Characteristics | | | |
|---|---|---|---|---|
| Characteristic | Battery A | Battery B | Battery C | Battery D |
| 1. Cold Cranking | 0 | 0 | 0 | 0 |
| Capability (CCA) | | | | |
| 2. Heat Resistance | 11 | 33 | 33 | 22 |
| 3. Reserve Capacity | 0 | 0 | 0 | 0 |
| 4. Vibration Resistance | 2 | 4 | 4 | 6 |
| 5. Sealed | 0 | 0 | 0 | 0 |
| 6. Warranty | 0 | 0 | 0 | 0 |
| 7. Cycle Capability | 0 | 0 | 0 | 0 |
| 8. Acid over plates (ml/ | 6 | 6 | 3 | 9 |
| AH-recomb) | | | | |
| WEIGHTED RATING | 19 | 43 | 17 | 21 |
| TOTAL | | | | |

Because various individuals may provide different answers to the questions presented by the battery selection system, a different identification or recommendation of an optimal or most appropriate battery may be provided in different individual cases. For example, two individuals living in similar areas and having identical vehicles may nevertheless have different preferences (e.g., one may prefer to keep the vehicle for eight years and will maintain the battery by adding water while another may prefer to keep the vehicle only two years and will not maintain the battery). In another example, an individual moving from a relatively low-traffic rural area to a relatively high-traffic urban area may obtain different recommendations based on the likely driving profile that is exhibited in these areas. In these or any of a variety of other examples, the battery selection system may provide different recommendations or suggestions.

For example, Table 5 illustrates responses to questions for a vehicle that utilizes optional accessories, which is driven infrequently for short distances on uncongested highways (or off-road) in cold climates, and that has a battery that is not maintained regularly (and a long warranty for the battery is desired). Table 5 also shows the weighting factors that are assigned for each of the battery characteristics being evaluated by the battery selection system. As shown in Table 5, the weighting factors for the various battery characteristics differ from those shown in Table 3. For example, Table 5 indicates that for this situation, reserve capacity is the most relevant battery characteristic.

The total weighting factors from Table 5 are applied to the ratings shown in Table 1 by multiplying the ratings by the total weighting factors (this assumes that the same four batteries are determined as being appropriate for each of these vehicles). The weighted ratings for each of the batteries is shown in Table 6, which indicates that in this case, Battery D would be identified or recommended as the most appropriate battery for this situation. As shown by these two examples, the answers provided by the consumers in the two examples described differ from each other, which results in a different battery being identified by the battery selection system as most appropriate for the particular situation.

TABLE 5

| | | Weighting Factors For Battery Characteristics | | | | | | | |
|---|---|---|---|---|---|---|---|---|---|
| | | | Heat | Reserve | Vibration | | | Cycle | Acid over |
| Question | Answer | CCA | Resistance | Capacity | Resistance | Sealed | Warranty | Capability | plates |
| 1. How many | 5,000 | | 0 | 4 | 0 | | | 3 | |
| miles is your car | | | | | | | | | |
| driven per year? | | | | | | | | | |
| 2. What is your | 48104 | 4 | 1 | | | | | | 0 |
| zip code? | | | | | | | | | |
| 3. Is your vehicle | Rural/ | | | 4 | 4 | | | | |
| driven primarily | Offroad | | | | | | | | |
| in urban or rural | | | | | | | | | |
| settings? | | | | | | | | | |
| 4. How many | 1 | | 0 | | | | | | |
| hours is your | | | | | | | | | |
| vehicle driven | | | | | | | | | |
| per day? | | | | | | | | | |
| 5. Does your | Yes | | | 4 | | | | | |
| vehicle have | | | | | | | | | |
| optional | | | | | | | | | |
| accessories (e.g. | | | | | | | | | |
| headlamp, | | | | | | | | | |
| winch, etc.)? | | | | | | | | | |
| 6. How long do | 5 Years | | | | | | 4 | | |
| you plan to keep | | | | | | | | | |
| your vehicle? | | | | | | | | | |
| 7. Do you desire | Yes | | | | | | 3 | | |
| a battery | | | | | | | | | |
| warranty greater | | | | | | | | | |
| than 2 years? | | | | | | | | | |
| 8. Do you | No | | | 4 | | 4 | | | 4 |
| maintain your | | | | | | | | | |
| battery? | | | | | | | | | |

| | | | | | | | | |
|---|---|---|---|---|---|---|---|---|
| WEIGHTING FACTOR | 4 | 1 | 16 | 4 | 4 | 7 | 3 | 4 |
| TOTAL | | | | | | | | |

TABLE 6

| | Weighted Ratings of Battery Characteristics | | | |
|---|---|---|---|---|
| | by Battery | | | |
| Characteristic | Battery A | Battery B | Battery C | Battery D |
| 1. Cold Cranking | 4 | 8 | 12 | 8 |
| Capability (CCA) | | | | |
| 2. Heat Resistance | 1 | 3 | 3 | 2 |
| 3. Reserve Capacity | 16 | 32 | 48 | 32 |
| 4. Vibration Resistance | 4 | 8 | 8 | 12 |
| 5. Sealed | 4 | 4 | 4 | 12 |
| 6. Warranty | 7 | 14 | 21 | 21 |
| 7. Cycle Capability | 3 | 3 | 3 | 9 |
| 8. Acid over plates (ml/ | 8 | 8 | 4 | 12 |
| AH-recomb) | | | | |
| WEIGHTED TOTAL | 47 | 80 | 103 | 108 |

The battery selection system may utilize a computing device, microprocessor, controller or programmable logic controller (PLC) for implementing a control program, and which provides output signals based on input signals provided by a user interface, sensor or that are otherwise acquired. Any suitable electronic or computing device of any type may be included in the battery selection system according to alternative embodiments and the various functions may be performed by one or more modules of the device (e.g., a display module, an information input module, an analysis module, an output module, etc.). For example, computing devices of a type that may comprise a microprocessor, microcomputer or programmable digital processor, with associated software, operating systems and/or any other associated programs to implement the control program may be employed. The controller and its associated control program may be implemented in hardware, software or a combination thereof, or in a central program implemented in any of a variety of forms according to alternative embodiments. According to alternative embodiments, the battery selection system may be configured to operate without the use of an electronic system and/or computing device. For example, the system may be implemented by hand and/or sight using charts and graphs or any other suitable means for selecting, identifying, or choosing a battery based on ratings and/or characteristics.

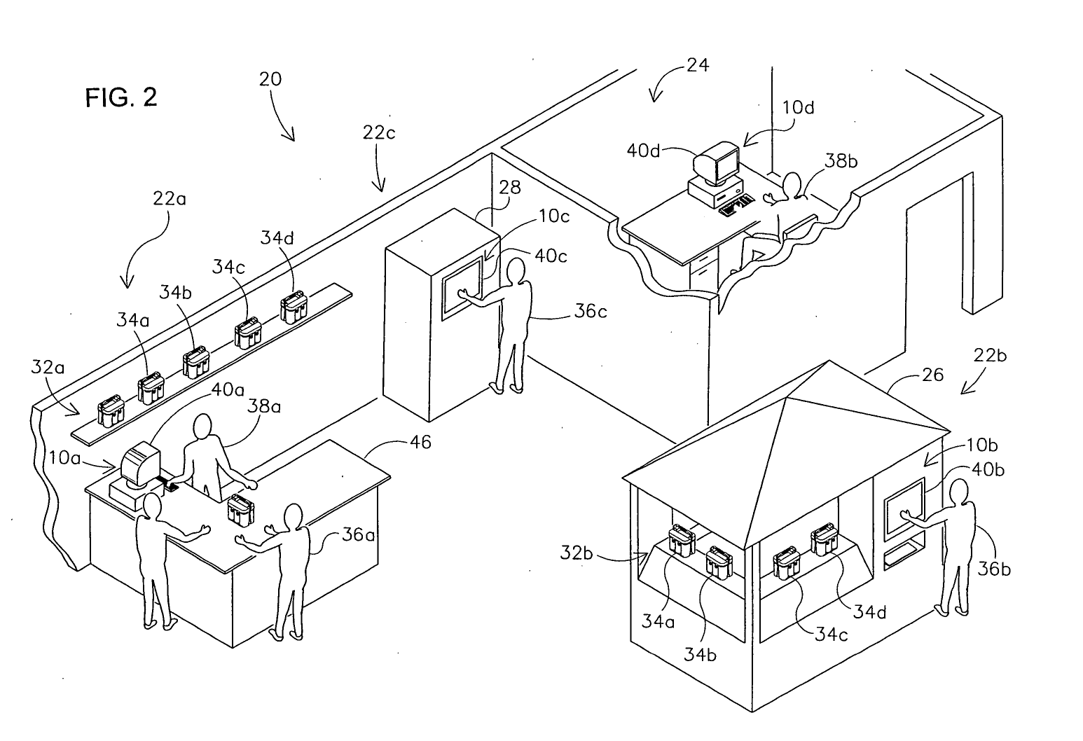

The battery selection system may be utilized in any of a variety of locations. Referring to FIG. 2, a sales or retail environment 20 is shown that includes a variety of implementations or embodiments of the battery selection system according to various exemplary embodiments. According to various alternative embodiments, battery selection systems may be utilized in other types of environments, such as service stations, manufacturing facilities, or in any other environment in which it is desirable for a consumer or other individual (e.g., mechanic, technician, salesperson, etc.) to identify or determine an appropriate battery for use in a particular application.

Referring to FIG. 2, implementations 10a, 10b, 10c, and 10d of the battery selection system are shown in a retail environment 20. Battery selection system 10a is shown according to a preferred embodiment in a shared sales space 22a. Sales space 22a includes a display 32a for batteries 34a through 34d that are offered for sale. A worker 38a is shown behind a counter 46 providing information to a computing device 40a (e.g., a personal or networked computer) of battery selection system 10a. According to a preferred embodiment, the worker inputs information which is provided by consumer 36a relating to various usage and/or price considerations (e.g., the consumer provides answers to questions presented by the battery selection system, which are then input by the worker).

Referring further to FIG. 2, battery selection system 10b is shown according to an alternative embodiment in a pavilion 26 of a sales space 22b. Pavilion 26 includes a display 32b for batteries 34a through 34d. A consumer 36b is shown providing information to a computing device 40b of pavilion 26. Referring further to FIG. 2, battery selection system 10c is shown according to an alternative embodiment in a structure shown as kiosk 28 of a sales space 22c. A consumer 36c is shown providing information to a computing device 40c of kiosk 28. Referring further to FIG. 2, a battery selection system 10d is shown according to an alternative embodiment in an individual work space 24. A worker 38b is shown providing information to a computing device 40d of battery selection system 10d.

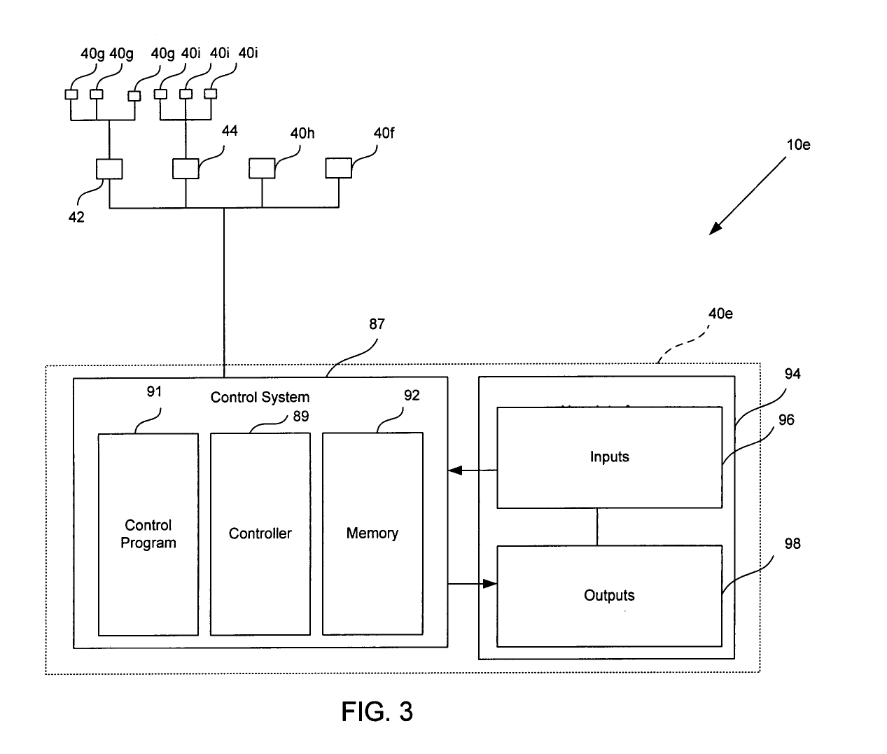

FIG. 3 shows another implementation 10e of the battery selection system according to an exemplary embodiment. A control system 87 comprising a controller 89 for running a control program 91 that is implemented by software, hardware, firmware, or combinations thereof is provided. Control program 91 may reside in a memory 92 or in hardware. Control program 91 comprises routines (e.g. programs, algorithms, logic, sequence of steps, calculations, etc.) and uses input signals 96 to provide output signals 98 (e.g., via a user interface 94 as shown in FIG. 3). For example, input signals representative of a type or use of a vehicle may be made available to the controller and used to provide output signals suggestive of a battery that is appropriate for the vehicle.

The battery selection system may be utilized by a variety of devices in a variety of ways according to any preferred or alternative embodiment such as those shown in FIG. 3. For example, the battery selection system may be accessed by a local computing device 40f such as a general purpose computer according to a preferred embodiment. The battery selection system may also be accessed by multiple computing devices 40g over a local network 42. The battery selection system may also be accessed by a remote computing device 40h such as a personal digital assistant, off-site computer, etc. The battery selection system may also be accessed by multiple computing devices 40i over a network such as the Internet 44.

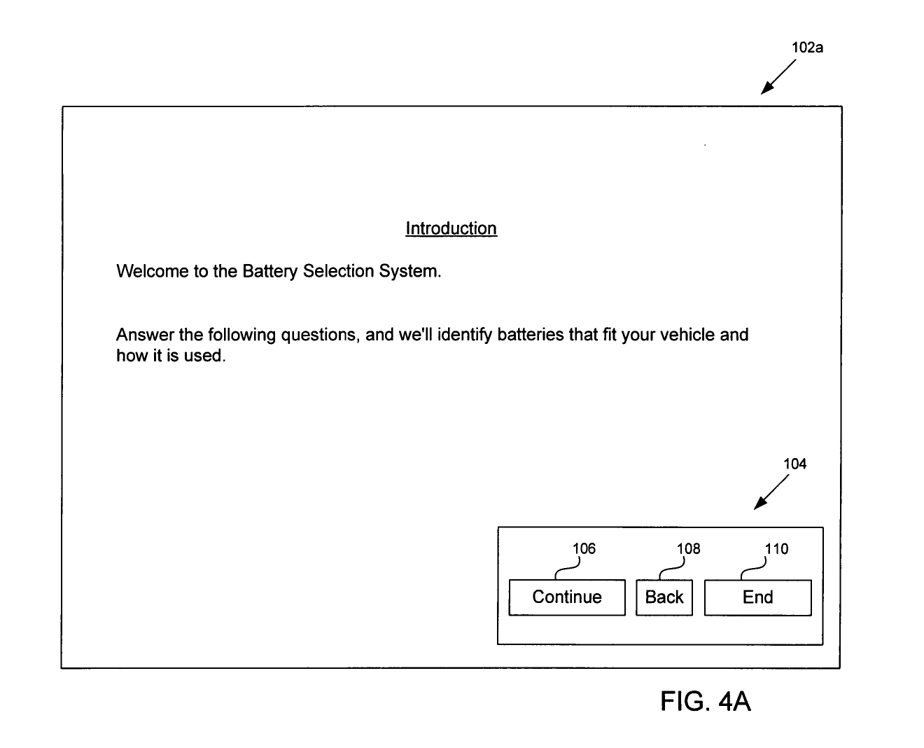

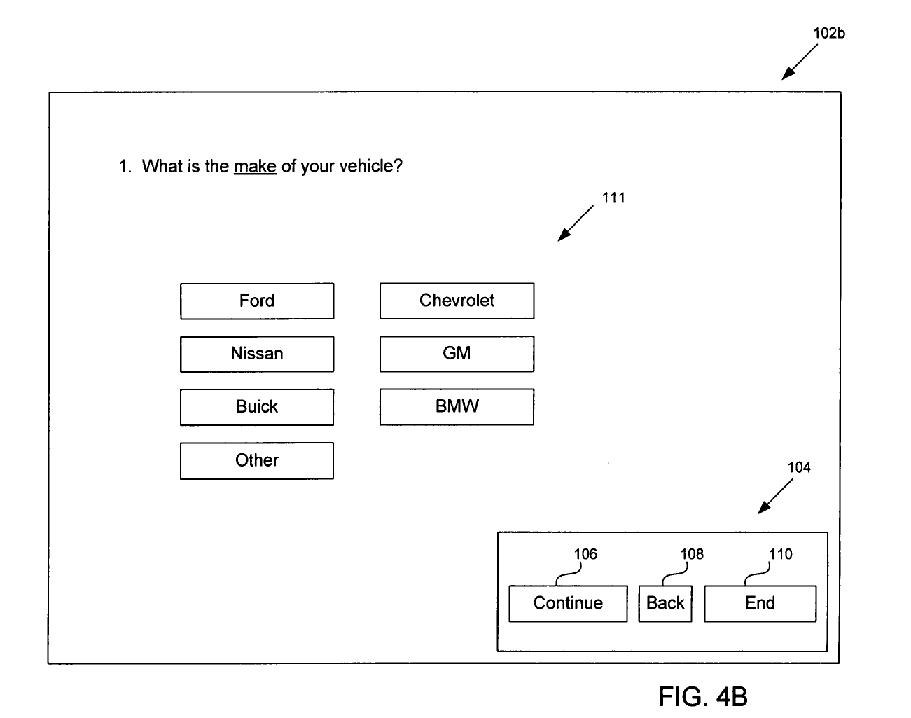

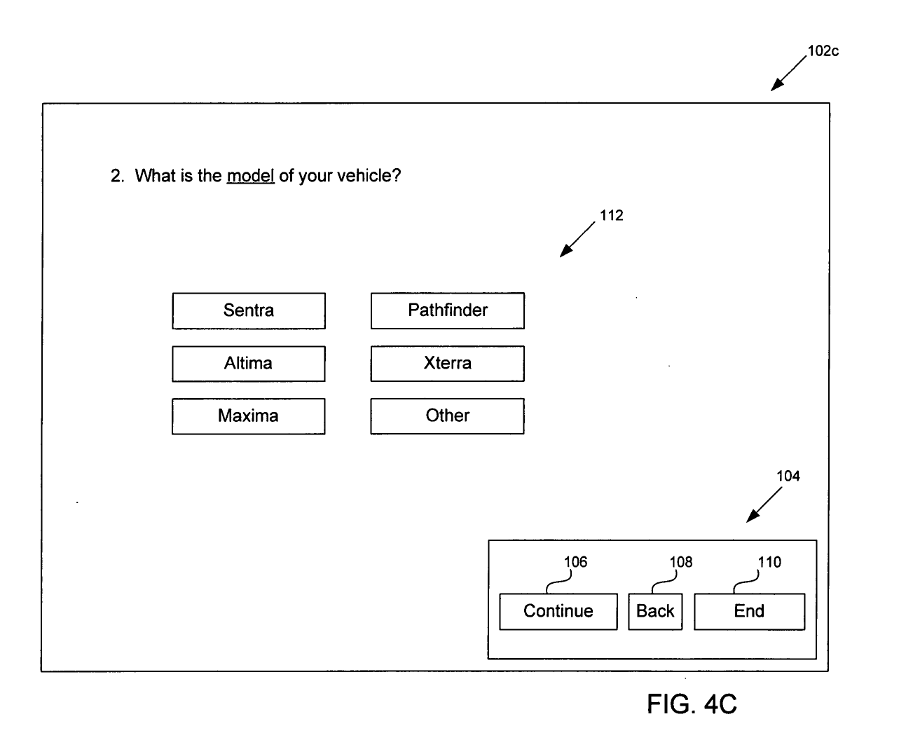

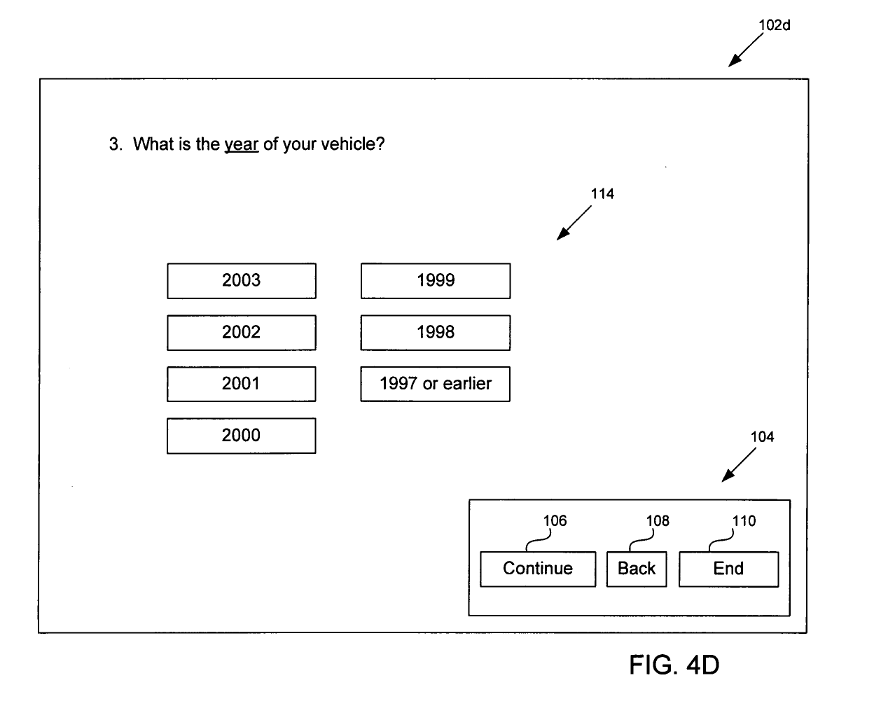

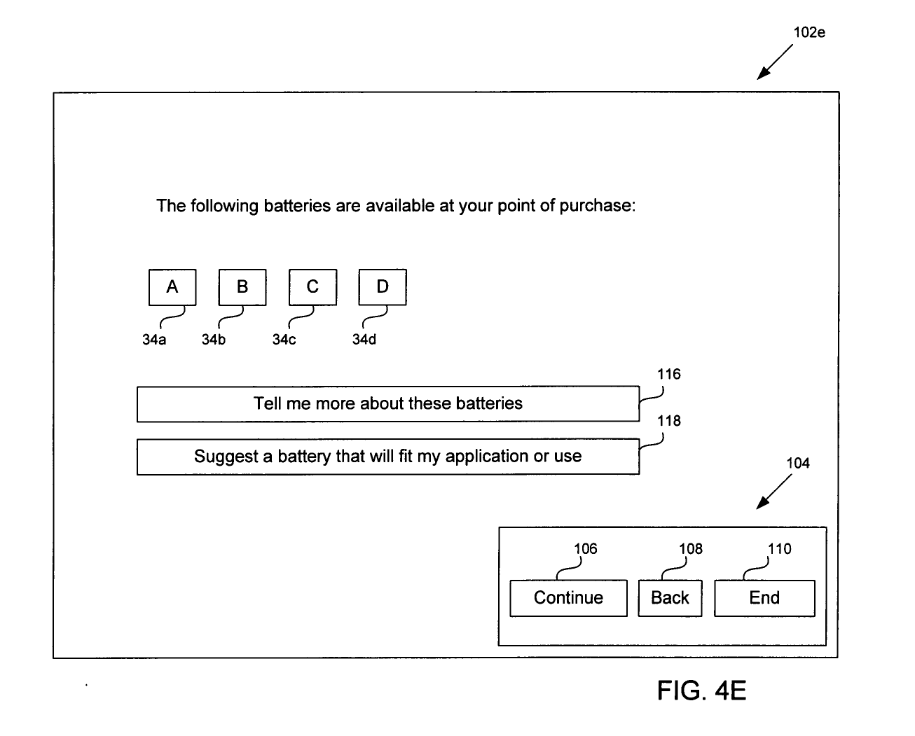

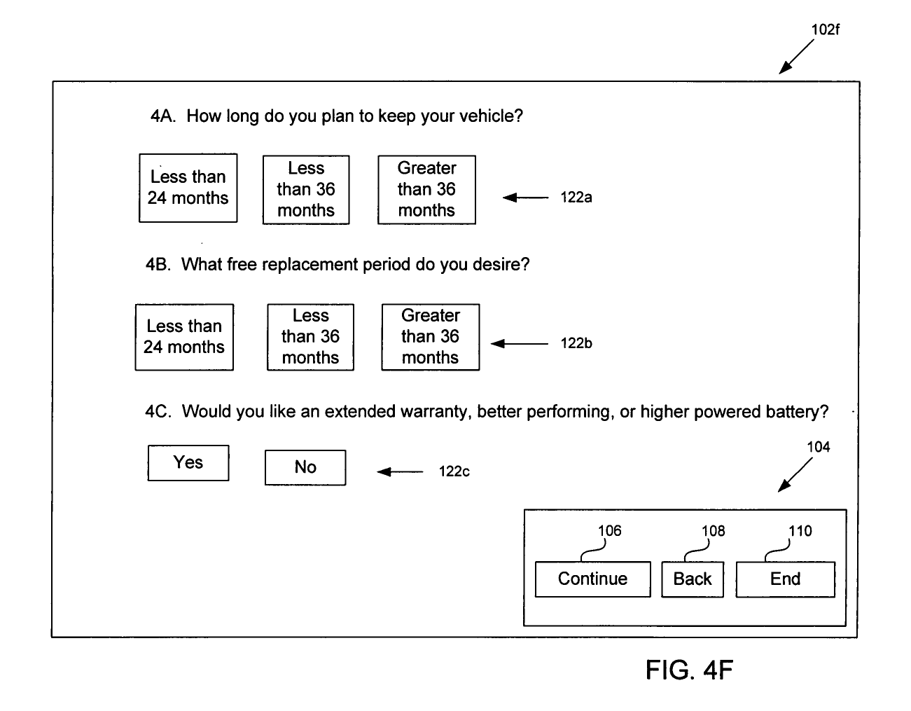

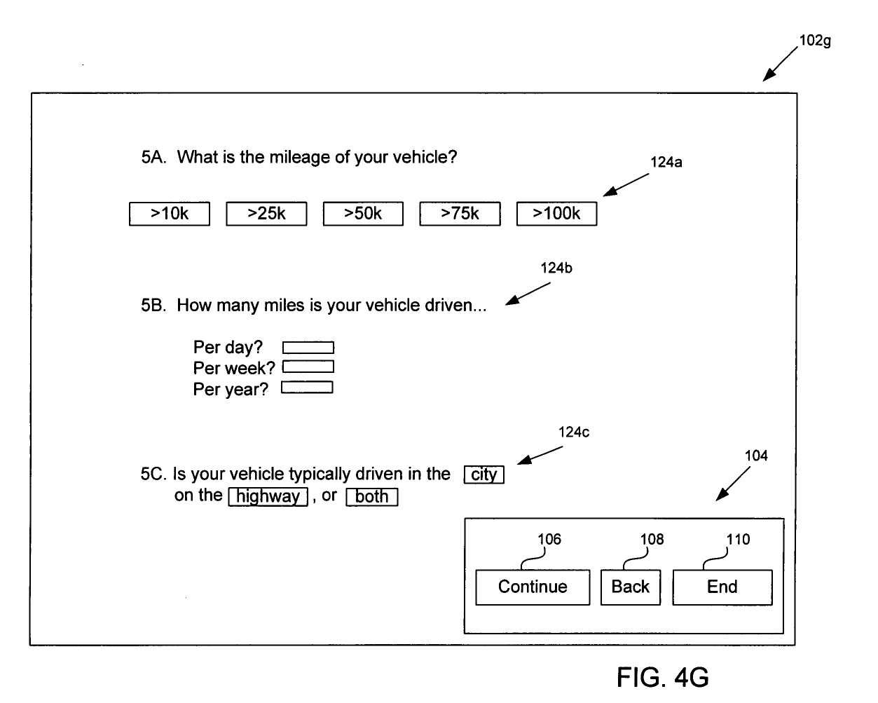

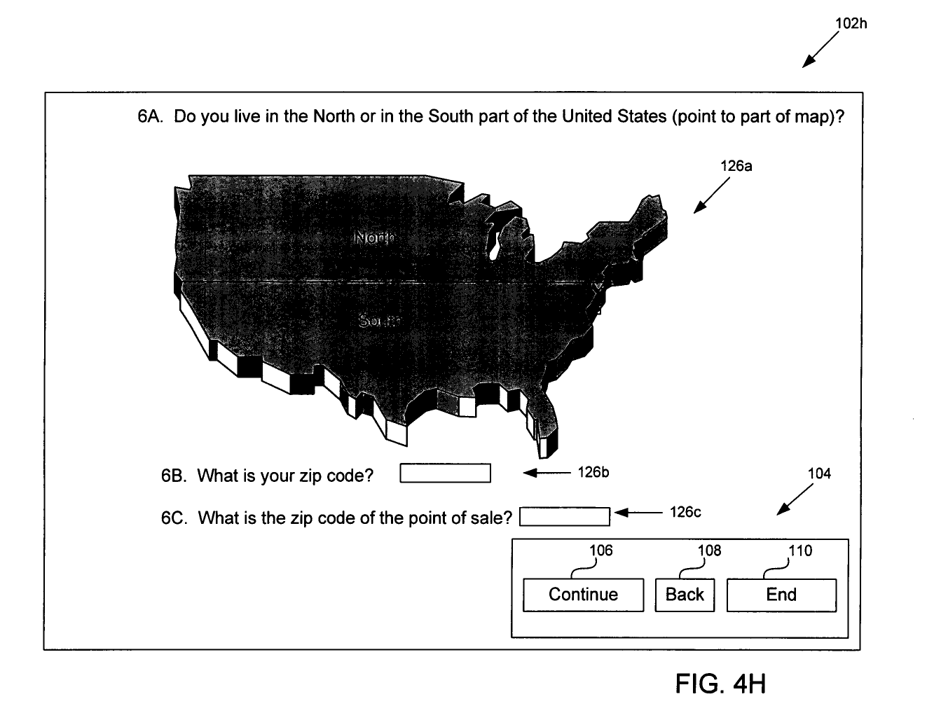

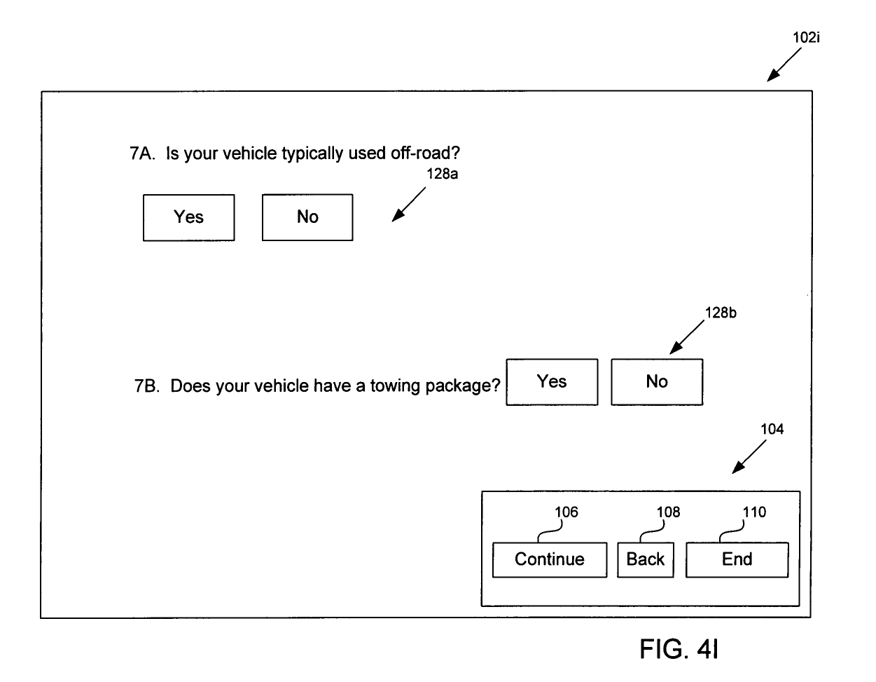

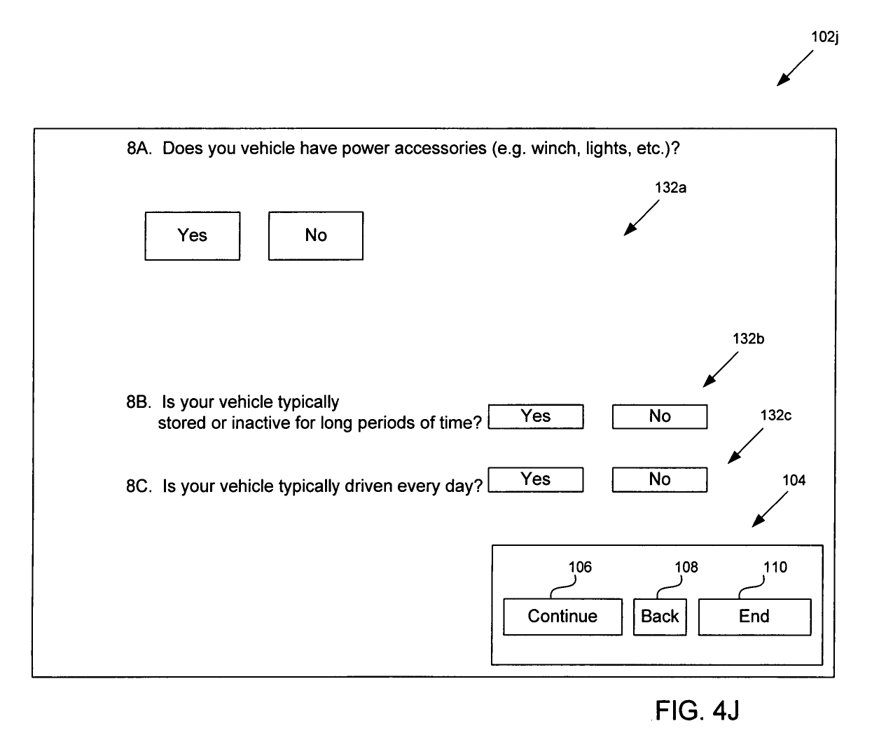

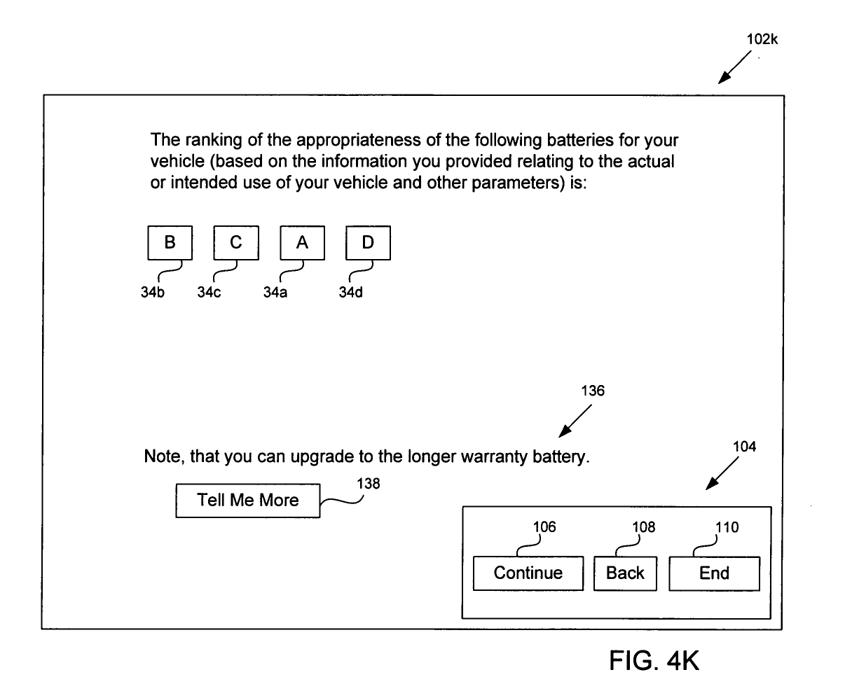

One nonexclusive example showing visual user interfaces or screens for presenting various aspects or features of the battery selection system to a user (e.g., utilizing a monitor or screen) is shown in FIGS. 4A through 4K according to an exemplary embodiment. For example, output signals may be presented to the user in the form of text, graphic, or other means to convey information (e.g., questions) from the battery selection system to a user. User interfaces 102a through 102k may be presented to the user utilizing a computing device and are illustrated in non-limiting fashion. One or more input devices (e.g., a keyboard, mouse, roller ball, touch-screen, touch-pad, light pen, etc.) may be provided to enable a user to provide input signals to the battery selection system (e.g., answers to questions, etc.).

User interfaces or screens 102a through 102k include a navigation bar 104 for navigation through the multiple user interfaces or screens of the battery selection system. Navigation bar 104 comprises input devices or areas that are electronically “clicked” to select a command or to view a particular associated object (shown as a “continue” button 106, a “back” button 108 and an “end” button 110) according to a preferred embodiment.

Referring to FIG. 4A, user interface 102a is shown according to an exemplary embodiment. User interface 102a serves as a “homepage” or initial screen and is intended to provide information relating to the function and operation of the battery management system according to an exemplary embodiment.

Referring to FIGS. 4B through 4D, user interfaces 102b through 102d for the input of information relating to the type of vehicle (e.g., year, make, and model) are shown according to exemplary embodiments. According to an alternative embodiment, the user may also select the general type of vehicle (e.g., boat, motorcycle, car, etc.).

User interface 102b includes input devices (shown as buttons 111 identifying various vehicle manufacturers) for the input of information relating to the make (i.e., manufacturer) of the vehicle (e.g., a touch-screen may be provided that allows a user to touch areas on a monitor or screen corresponding to the buttons to select or “press” a button). Input devices 111 may include text and/or graphics (e.g., logos for vehicle manufacturers). User interface 102c includes input devices (shown as buttons 112 identifying various model of vehicles) for the input of information relating to the model of the vehicle. User interface 102d includes input devices (shown as buttons 114 identifying various years) for the input of information relating to the year of the vehicle.

User interface 102e (FIG. 4E) displays output signals 34a through 34d that are representative of batteries that the battery selection system indicates as being appropriate for the vehicle based on the year, make, and model of the vehicle (e.g., these batteries are available for use with a vehicle satisfying the year, make, and model criteria entered by the user). Signals 34a through 34d may be presented in the form of a list, as graphics, icons, or in any other suitable manner. Such signals may also be presented in a particular order (e.g., based on ratings of battery characteristics, such as shown in Table 1) or may be presented in another manner (e.g., in order by cost, availability, features, alphabetically by manufacturer or model, etc.).

An input device (shown as a button 116) is provided to allow the user to provide a request for additional information relating to batteries represented by signals 34a through 34d (e.g., cold cranking capability, reserve capacity, group size, warranty, price, etc.). An input device (shown as a button 118) for providing a request to the battery selection system to identify or recommend one of the batteries represented by signals 34a through 34d is also provided according to an exemplary embodiment.

A user who selects button 118 may be presented with user interface 102f (FIG. 4F), User interface 102f includes input devices 122a through 122c for the input of information relating to the period the vehicle will likely be used. Referring to FIG. 4G, user interface 102g having input devices 124a through 124c for the input of information relating to the “drive profile” or pattern of use of the vehicle is shown according to a preferred embodiment.

Referring to FIG. 4H, a user interface 102h having input devices 126a through 126c for the input of information relating to the region or geography in which the vehicle will likely be used is shown according to an exemplary embodiment. Input device 126a is shown as a map. A portion of the map (e.g., north/south, a particular state or county, etc.) may be selected by a user to identify a particular region or area in which the user lives. The user may also enter a zip code into a free form text field in response to the question associated with input devices 126b and 126c (e.g., to input the zip code of the user's residence and the zip code of the retail outlet where the battery will be purchased). Information derived from inputs using input devices 126a through 126c may provide an indication as to the likely location that a vehicle using the battery will be used.

Referring to FIGS. 41 to 4J, user interfaces 102i and 102j having input devices 128a, 128b, and 132a for the input of information relating to whether the vehicle will likely be used in off-road conditions or with optional accessories is shown according to an exemplary embodiment. User interface 102j also includes input devices 132a through 132c for the input of information relating to the use of the vehicle that may affect the reserve capacity of the battery (e.g., whether the vehicle is driven regularly, stored for long periods, etc.).

Referring to FIG. 4K, a user interface 102k for the display of output signals 34a through 34d representative of the batteries shown initially in FIG. 4E. According to an exemplary embodiment, based on the information input by the user, the output signals 34a through 34d are provided in an order different from that shown in FIG. 4E as an indication that the battery represented by output signal 34b is most appropriate for the user. Thus, output signals 34a through 34d are shown in the order of most to least appropriate for the user from left to right. Other ways of presenting the most appropriate battery for the user may also be utilized (e.g., showing an icon representing only the most appropriate battery, etc.).

Another output signal 136 may also be provided to indicate that further information (e.g., pricing, coupons, tie-in or associated products, warranty information, etc.) may be provided by the user interface. An input device (shown as button 138) may be provided to enable the user to obtain such further information. According to other exemplary embodiments, other information may also be presented to the user by the battery selection system, including but not limited to associated components or accessories for the battery or vehicle, promotional materials, attributes of a particular battery, pick-up and order or purchase information, etc. The battery selection system may also present screen savers or information screens that display advertisements or other information. According to an alternative embodiment, the battery selection system may include functionality that allows a user to access a battery or vehicle manufacturer's Internet website or other information that may advantageously be presented to the user.

While FIGS. 4A to 4K illustrate one embodiment of user interfaces or screens presented by a battery selection system according to an exemplary embodiment, other embodiments may differ. For example, additional and/or different questions may be presented according to various alternative embodiments. According to other alternative embodiments, the order in which the screens are presented to a user may differ.

It should be noted that the questions illustrated as being presented by the battery selection system in FIGS. 4A to 4K differ from those shown in Tables 3 and 5 above. According to various exemplary embodiments, the battery selection system may utilize any number and type of questions to elicit information related to the use of the battery and/or other characteristics. According to an alternative embodiment, the battery selection system may obtain information from a consumer or other individual that is not used to rank various batteries (e.g., the battery selection system may ask the age of the individual, the individual's address, yearly income, or other information). Such information may be stored by the battery selection system and/or used for other purposes (e.g., to generate mailing lists, to identify other products that may be of interest to the user, etc.).

It should also be noted that while the embodiment described with respect to Tables 3 and 5 utilizes discrete questions to provide weighting factors for the various battery characteristics (e.g., based on the answer to a single question, the battery selection system assigns weighting factors to one or more battery characteristics), more than one question (e.g., a series of related questions) may be utilized to determine an appropriate weighting factor (e.g., the battery selection system may generate weighting factors by inferring certain information based on information provided by a user). For example, based on a user's answer to a series of questions related to the location of use of a vehicle (e.g., home zip code and/or address, location of retail establishment, location of work, general geographic area), the battery selection system may obtain a profile or characterization of the driving profile (e.g., the combination of the various answers may indicate that the individual will use the vehicle in a generally cold environment, which in turn may implicate one or more battery characteristics). Accordingly, rather than assigning weighting factors to various battery characteristics based on discrete information, the battery selection system may utilize sets or groups of information (e.g., multiple answers to questions related to a driving profile) to determine appropriate weighting factors.

It is important to note that the construction and arrangement of the elements of the battery selection system as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in questions, algorithms or formulae used to assign weighting factors and/or determine the ranking of the batteries, etc.) without materially departing from the novel teachings and advantages of the subject matter disclosed in this application. For example, according to an alternative embodiment the user interfaces may integrate promotional materials for related items for the type of vehicle (e.g., filter, wipers, etc.). According to other alternative embodiments, the user interfaces may display educational information about the vehicle or the battery for the vehicle (e.g., car care). According to another alternative embodiment, the user interfaces may be provided in various languages. According to another alternative embodiment, the user interfaces are part of a touch screen. According to other alternative embodiments, the input device may be a keyboard, mouse, keypad, display (e.g., touch screen), etc. According to another alternative embodiment, the drive profile of the vehicle may be recorded over actual use of the vehicle, and stored (e.g., or a memory device) and downloaded to the battery selection system. Accordingly, all such modifications are intended to be included within the scope of the present inventions. The order or sequence of any process or method steps may be varied or re-sequenced according to alternative embodiments. In any claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit of the present inventions.

1. A method of selecting a battery for a vehicle comprising:
identifying a plurality of batteries;
obtaining ratings for a plurality of characteristics for each of the plurality of batteries;
obtaining information relating to the usage of the vehicle; and
identifying a battery for use with the vehicle based on the ratings and the information relating to the usage of the vehicle.

2. The method of claim 1 wherein the step of identifying a plurality of batteries utilizes information obtained regarding at least one of the make, model, and year of manufacture of the vehicle.

3. The method of claim 1 wherein the step of obtaining ratings for a plurality of characteristics includes utilizing at least one of a lookup table and a database.

4. The method of claim 1 wherein the plurality of characteristics includes at least one of cold cranking capability, heat resistance, reserve capacity, vibration resistance, and cycle capability.

5. The method of claim 1 wherein the plurality of characteristics include at least one of an economic characteristic and a warranty characteristic.

6. The method of claim 1 wherein the step of obtaining information relating to the usage of a vehicle comprises obtaining information related to at least one of location of vehicle use, the amount of vehicle use, the environment in which the vehicle is used, and the use of accessories with the vehicle.

7. The method of claim 1 wherein the step of obtaining information relating to the usage of a vehicle comprises obtaining information relating to maintenance of the battery and the amount of time the vehicle will be owned.

8. The method of claim 1 further comprising obtaining information relating to at least one of the desired cost of the battery and the desired warranty of the battery, wherein the step of identifying a battery for use with the vehicle comprises utilizing the information relating to at least one of the desired cost of the battery and the desired warranty of the battery.

9. The method of claim 1 wherein the step of identifying a battery for use with the vehicle comprises providing at least one weighting factor based on the information relating to the usage of the vehicle.

10. The method of claim 9 wherein the step of identifying a battery for use with the vehicle comprises applying the at least one weighting factor to at least one of the ratings.

11. The method of claim 10 wherein the step of applying the at least one weighting factor comprises multiplying at least one of the ratings by the at least one weighting factor to provide weighted ratings for the plurality of characteristics.

12. The method of claim 11 wherein the step of identifying a battery for use with the vehicle comprises summing the weighted ratings for each of the plurality of characteristics for each of the plurality of batteries.

13. The method of claim 12 wherein the step of identifying a battery for use with the vehicle comprises ranking the plurality of batteries based on the sum of the weighted ratings for each of the plurality of batteries.

14. A method of identifying an optimal battery for an application comprising:
identifying a plurality of batteries for use in the application;
obtaining ratings for a plurality of characteristics for each of the plurality of batteries;
obtaining information relating to usage characteristics of the application;
weighting a plurality of the ratings based on the information relating to usage characteristics of the application; and
utilizing the weighted ratings to identify an optimal battery for the application.

15. The method of claim 14 wherein the application comprises a vehicle.

16. The method of claim 15 wherein the step of identifying a plurality of batteries utilizes information obtained regarding at least one of the make, model, and year of the vehicle.

17. The method of claim 14 wherein the step of obtaining ratings for a plurality of characteristics includes utilizing at least one of a lookup table and a database.

18. The method of claim 14 wherein the plurality of characteristics includes at least one of cold cranking capability, heat resistance, reserve capacity, vibration resistance, and cycle capability.

19. The method of claim 14 wherein the plurality of characteristics include at least one of an economic characteristic and a warranty characteristic.

20. The method of claim 14 wherein the step of obtaining information relating to the usage of a vehicle comprises obtaining information related to at least one of location of use, the amount of use, the environment in which the use will occur, and the use of accessories with the application.

21. The method of claim 14 wherein the step of obtaining information relating to the usage characteristics of the application comprises obtaining information relating to maintenance of the battery.

22. The method of claim 14 wherein the step of weighting a plurality of the ratings comprises providing a weighting factor based on at least part of the information relating to usage characteristics.

23. The method of claim 22 wherein the step of weighting a plurality of the ratings comprises applying at least one weighting factor to a rating to provide a weighted rating.

24. The method of claim 14 wherein the step of utilizing the weighted ratings to identify an optimal battery comprises totaling the weighted ratings for the plurality of characteristics for each of the plurality of batteries.

25. The method of claim 14 further comprising presenting at least one of pricing information, coupon information, sales promotion information, promotional information, information relating to associated products, warranty information, and order information.

26. A system for selecting a battery comprising:
a user interface for facilitating input of information relating to a type of vehicle and the use of the vehicle; and
an electronic system for identifying a plurality of batteries for use with the vehicle, obtaining ratings of a plurality of characteristics for the plurality of batteries, and identifying one of the plurality of batteries as most appropriate based on the ratings and the information relating to the use of the vehicle.

27. The system of claim 26 wherein the information relating to a type of vehicle comprises at least one of a make, model, and year of a vehicle.

28. The system of claim 26 wherein the information relating to the use of the vehicle comprises at least one of the mileage of the vehicle and the location in which the vehicle is intended to be used.

29. The system of claim 28 wherein the information relating to the location in which the vehicle is intended to be used comprises a zip code.

30. The system of claim 26 wherein the information relating to the use of the vehicle comprises a driving profile for the vehicle.

31. The system of claim 26 wherein the driving profile comprises at least one of the amount of miles to be accumulated in a defined period, an environment in which the vehicle is intended to be used, and the weather in the location where the vehicle is intended to be used.

32. The system of claim 26 wherein the plurality of characteristics comprise at least one of a cold cranking capability, a heat resistance, a reserve capacity, a vibration resistance, and a cycling capability of the battery.

33. The system of claim 26 further comprising a display for presenting information to a user of the system.

34. The system of claim 26 wherein the display presents questions to the user that are configured to elicit information relating to the use of the vehicle.

35. The system of claim 26 wherein the electronic system comprises a computing device.

36. The system of claim 26 wherein the electronic system includes an analysis module configured to provide weighting factors for at least a plurality of the ratings.

37. The system of claim 36 wherein the analysis module is configured to apply the weighting factors to the plurality of ratings.

38. The system of claim 26 wherein the system is implemented in a retail environment.

39. The system of claim 26 wherein the system utilizes a network to obtain the ratings.

40. The system of claim 26 wherein the system is accessible over a computer network.

41. The system of claim 26 further comprising at least one input device for facilitating input of information and selected from a mouse, a roller ball, a touch pad, a touch screen, a keyboard, and a light pen.

42. The system of claim 26 wherein the user interface is configured to display additional information relating to at least one of sales promotions, pricing, warranty, associated products, product ordering, product availability, and coupons.
